(19) United States
(12) Patent Application Publication
(10) Pub. No.: US 2021/0030211 A1
(43) Pub. Date: Feb. 4, 2021

(54) STACKABLE FRYING PANS AND SAUCEPANS

(71) Applicant: M/s. Stovekraft Limited, Karnataka (IN)

(72) Inventor: Lakshmi Naga Venkata Sudarshana Mukharji Pothakamuri, Karnataka (IN)

(73) Assignee: M/s. Stovekraft Limited, Karnataka (IN)

(21) Appl. No.: 16/567,006

(22) Filed: Sep. 11, 2019

(30) Foreign Application Priority Data
Jul. 30, 2019 (IN) 201941030653

(51) Int. Cl. A47J 45/06; A47J 27/12

(52) U.S. Cl. CPC A47J 45/063; A47J 27/12

(57) ABSTRACT

A stackable cookware and more specifically it relates to frying pans and saucepans. The stackable cookware with stackable handles may include a plurality of pans which may be stacked within one another. The stackable handles have an upward projection in the proximal end of the top surface of the handle and a slot depression in the bottom surface of the handle such that the upward projection in the top surface of a bottom handle fits and locks in with the slot depression in the bottom surface of a top handle. The upward projection feature also helps in stacking of the containers and to get a grip while moving these stacked containers.

### STATEMENT OF RELATED APPLICATIONS

This patent application is the non-provisional of and claims priority on and the benefit of Indian application no. 201941030653 having a filing date of 30 Jul. 2019.

### BACKGROUND OF THE INVENTION

Consumers generally tend to use multiple cookware that comes in various sizes. Storing such cookware becomes cumbersome and inconvenient. Certain prior arts disclose cooking vessels with removable handles for saving space. However, such removable handles are easily lost or damaged and can complicate the use of multiple burners or heat sources for cooking.

Another existing problem with stacking multiple vessels is that as the stack pile grows, the stacked vessels tend to skew or tilt toward one direction thereby making the stack unstable.

Cookware may be stacked such that a smaller cookware vessel is placed inside the larger cookware vessel, with the lids of the cookware vessels placed on top of the stack. Some cooking vessels have handles of varying length. The notch parts on the handles are sharp, unsafe and would also damage other vessels. As a result, storage and organization of cookware may consume space and may be difficult to store in certain locations, such as kitchen cabinets.

The present invention aims to overcome the above problems of stacking and storing cookware. The present invention relates to stackable cookware, more specifically it relates to frying pans and saucepans, including a plurality of pans or vessels. The novel feature of this invention is the upward projection locking mechanism. The upward projection is close to the upward wall of the vessels and this design helps secure the lid of cookware articles during their storage and transport. The upward projection feature also helps in the stacking of the containers and to get a grip while moving these stacked containers. The upward projection is designed to securely fit into the slot of the bottom profile of the handle to lock the vessels together, thus helping in the stacking of the containers.

### TECHNICAL FIELD

The present invention relates to a stackable cookware with long stackable handles and more specifically it relates to frying pans and saucepans.

### PRIOR ART

EP1959804B1 titled “Handle for stackable item of kitchen equipment and set of such handles and items of equipment” discloses a handle for cookware with a locking projection that is adapted to engage with a reception zone provided on another handle of another cooking utensil.

US20180271331A1 titled “Cookware article and utensil handle” discloses a stackable cookware article system that includes a stackable handle having a grip portion including a projection that extends downward from the lower surface of the handle and a hole configured for stacking with similarly configured handles.

EP2037780 B1 titled“Stacking pan set” discloses set of two or more of inter-stacking cooking pans with integrated handles and lids. A localised rim recess formed in the top rim of each but the smallest pan of the set, sufficient to allow a proximal portion of the handle of the next smaller pan to pass through that rim recess while the body of the smaller pan is received completely within the body of the next larger pan.

AU2013200083A1 titled “Stackable Cooking Pans and Lids” discloses a set of stackable or nestable cooking pans with handles and lids where each pan is progressively smaller and where the smaller pan can fit into the next larger pan. The external surface of the base of the smaller cooking pan rests flat on the internal surface of the base of the next larger cooking pans and the recess of the handle of the smaller one of the cooking pans clears the level portion of the upper rim edge of the next larger one of the cooking pans of the set. This invention also relates to sets of stackable or nestable bakeware.

EP3210503A1 titled “Stackable cookware and lids” discloses stackable cookware system where the pans are of decreasing size such that smaller pan completely fits into next larger pan. The cookware has female and male alignment features, length of the second handle is less than the first length of the first handle and there is no upward projection interlocking mechanism between handles, therefore, the cookware can move relative to each other in a horizontal plane.

### BRIEF SUMMARY OF THE INVENTION

The present invention relates to a stackable cookware and more specifically it relates to frying pans and saucepans.

In accordance with one or more embodiments of the present disclosure, the stackable cookware with stackable handles may include a plurality of pans which may be stacked within one another.

In another embodiment of the present invention, the stackable cookware may also optionally include a plurality of accompanying lids.

In another embodiment, the stackable cookware may be of varying size.

A stackable cookware comprising a pan having a closed bottom surface, an open top, and a sidewall, said sidewall extending upwardly from a bottom surface of the said pan to the pan rim, a long stackable handle mounted to the sidewall of the said pan wherein the said handle has an upward projection in the proximal end of the top surface of the handle and a slot depression at the bottom surface of the handle to enable locking, the said handle may include an open hole or aperture to enable hanging the pan, and an optional lid to rest upon said pan rim, said lid having a knob on its top. The knob can be of various shapes such as round, triangular, square, rectangle, octagon, or hexagon.

A stackable cookware set comprising a plurality of pans of varying size with long stackable handles mounted to the sidewall of the said plurality of pans, a plurality of optional lids, a first larger pan with a single long stackable handle, a second smaller pan with a second long stackable handle, and a third smallest pan with a third long stackable handle, wherein the first larger pan is the outermost pan in the stack and the third smallest pan is the innermost pan in the stack, each pan having a progressively smaller diameter and height such that the smaller pan fits within the next larger pan, the said handle has an upward projection at the top surface of the handle and a slot depression at the bottom surface of the handle such that the said upward projection in the handle of a first pan fits and locks in with the slot depression in the handle of the second pan. Each pan may have a corresponding optional lid which may include a knob on its top surface; said knob can be of various shapes. The lids may be positioned on top of any one of the pan rim or may be specific to specific pans.

Each stackable cookware article has a single long stackable handle extending from a sidewall of the pan. The cookware has sidewalls extending upwardly from a bottom surface of the pan to a pan rim. The cookware may be aligned and placed within the cavity of another cookware unit for stacking, accommodating a plurality of pans. The cookware is designed in such a way that the smaller one of the cookware pan is stacked within a next larger one of the cookware pan.

One embodiment of the present invention illustrates the upward projection locking mechanism of the stackable handles. The handles may be positioned so as to stack on top of each other in a stacked handle configuration. The stackable handles may be of similar length and design irrespective of the cookware size, thereby being cost-effective.

During stacking of the cookware article, the upward projection in the proximal end of the upper surface of the handles prevents the external surface of the base or bottom surface of one smaller pan from resting flat on the internal surface of the base of a second larger pan, thus preventing damage to the inner coating of the pans. This arrangement also leaves considerable space or gap between the bases of two consecutive pans. Each pan is spaced apart from an equal distance when stacked and this said space can be further utilized to store a lid, if any, thereby saving space. The stackable cookware is held in a stable stacked position using the handles. The upward projection also helps to get a better grip against the thumb while carrying the stacked containers and also to secure the lid during storage and transport.

### BRIEF DESCRIPTION OF THE DRAWINGS

FIG. 1 shows a side view of a stackable frying pan set in accordance with one or more embodiments of the present invention.

FIG. 2 shows an additional view of a set of stackable frying pan with stackable handles according to another embodiment of the present invention.

FIGS. 3A and 3B depict top-view of a set of stackable cookware with stackable handles in accordance with one or more embodiments of the present invention.

FIG. 4 shows a side view of a stackable saucepan set according to another embodiment of the present invention.

FIG. 5 illustrates a stackable handle embodiment.

FIG. 6 illustrates a stackable handle in accordance with one or more embodiments of the present invention.

FIG. 7 illustrates a side view of the stackable handle in accordance with one or more embodiments of the present invention.

### DETAILED DESCRIPTION OF THE PREFERRED EMBODIMENTS

For the purpose of promoting an understanding of the invention, reference will now be made to the embodiments illustrated in the Figures and specific language will be used to describe them. It will nevertheless be understood that no limitation of the scope of the invention is thereby intended. It will be understood by those skilled in the art that the foregoing general description and the following detailed description are exemplary and explanatory of the invention and are not intended to be restrictive thereof.

Such alterations and further modifications in the illustrated system, and such further applications of the principles of the invention as would normally occur to those skilled in the art are to be construed as being within the scope of the present invention.

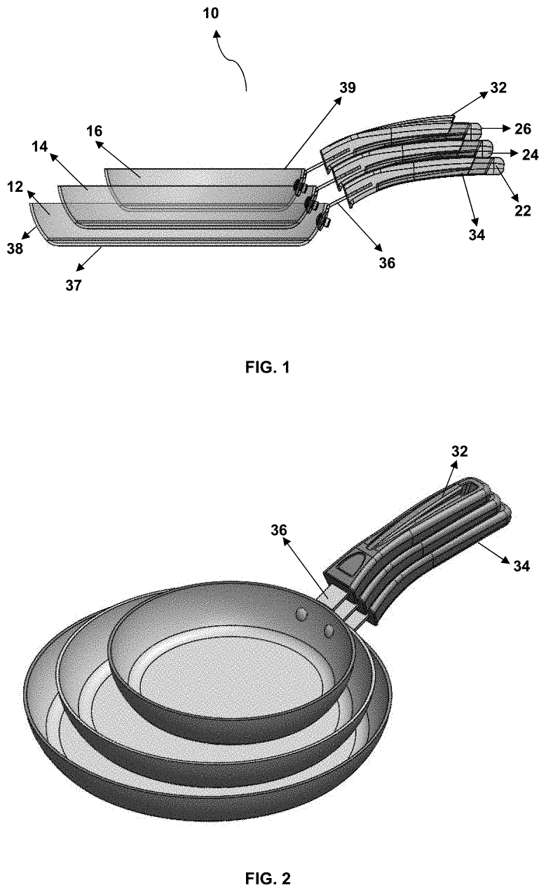

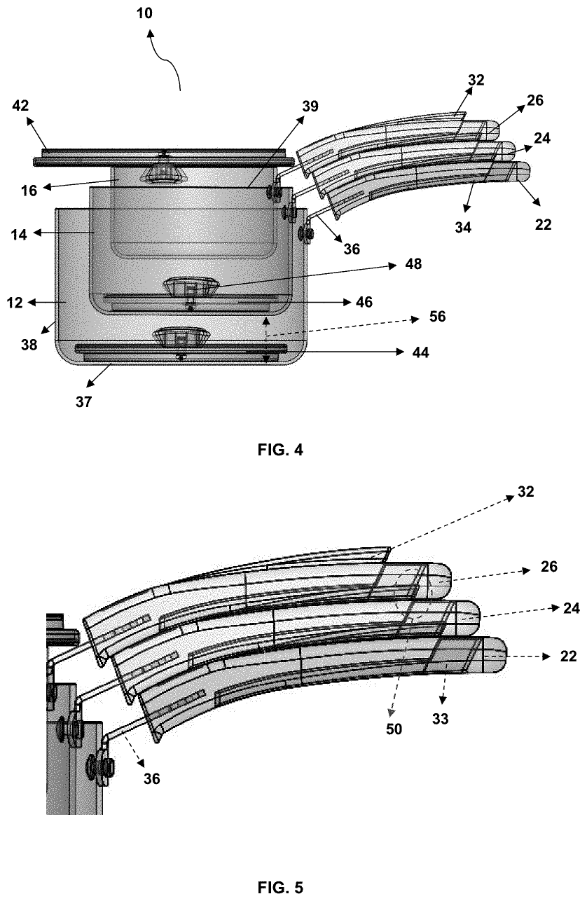

FIG. 1 shows a side view of a stackable frying pan set 10 in accordance with one or more embodiments of the present invention. The stackable frying pan set may include a plurality of pans 12, 14, 16. The stackable set may also optionally include a plurality of accompanying lids 42, 44, 46 as shown in FIG. 4. In the illustrated example, the stackable frying pan set may include a first larger pan 12 with a first single long stackable handle 22, a second smaller pan 14 with a second single long stackable handle 24, and a third smallest pan 16 with a third single long stackable handle 26 wherein the first larger pan is the outermost pan in the stack and the third smallest pan is the innermost pan in the stack, each pan having a progressively smaller diameter and height such that a smaller pan fits within the next larger pan.

Each has an optional lid 42, 44, 46 which may include a knob 48 on its top surface as shown in FIG. 4. The knob can be of various shapes such as round, triangular, square, rectangle, octagon, or hexagon. The lids may be positioned on top of any one of the pan rim 39 or may be specific to specific pans.

Each cookware article has a single long stackable handle 22, 24, 26 extending from one side of the sidewall 38 of the pan. Each stackable handle has an upward projection 32 in the top surface of the handle and a slot depression 34 in the bottom surface of the handle such that the upward projection in the top surface of a bottom handle 22 fits and locks in 50 with the slot depression in the bottom surface of a top handle 24 to enable locking, as shown in FIG. 7. The slot depression in the bottom surface of the handle is preferably a curved slot depression.

The cookware has sidewalls extending upwardly from a bottom surface 37 of a pan to a pan rim. The cookware may be aligned and inserted into the cavity of another cookware unit for stacking, accommodating a plurality of pans. The cookware is designed in such a way that the smaller one of the cookware pan is stacked within a next larger one of the cookware pan 10.

FIG. 2 shows an additional view of a set of stackable frying pan with stackable handles according to another embodiment of the present invention, as illustrated in FIG. 1. The handles are attached to the pan sidewall with one or more metallic inserts 36. The metallic insert is preferably a stainless steel insert.

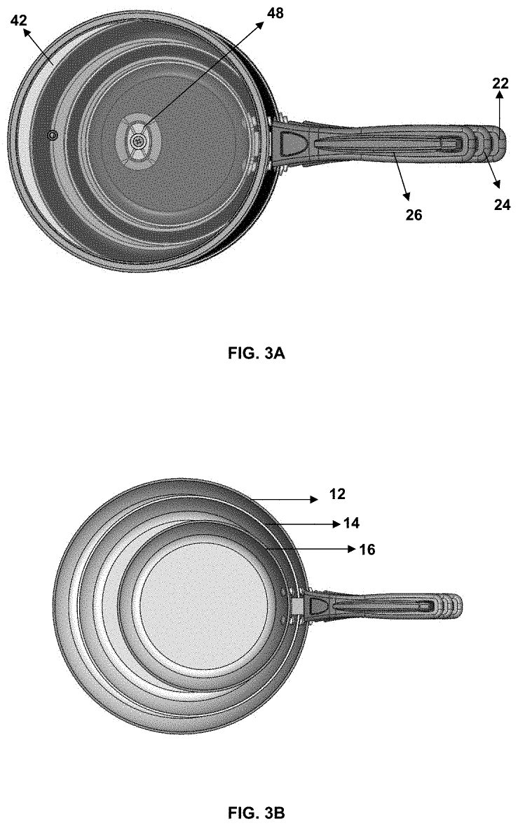

FIGS. 3A and 3B depict top-view of a set of stackable cookware 10 with stackable handles 24, 26, 28 in accordance with one or more embodiments of the present invention. FIG. 3A depicts the stackable cookware set along with stackable handles and an optional lid 42. FIG. 3B depicts the stacking arrangement of the cookware set without a lid. The handles allow for the cookware to be gripped or carried and also accommodate stacking.

FIG. 4 shows a side view of a stackable saucepan set 10 in accordance with one or more embodiments of the present invention, as illustrated in FIG. 1. During stacking of the cookware set, the upward projection 32 in the top surface of the handles prevents the external surface of the base or bottom surface 38 of one smaller pan 16 from resting flat on the internal surface of the base of a second larger pan 14, thus preventing damage to the inner coating of the cookware. This arrangement also leaves considerable space or gap 56 between the bases of two consecutive pans. Each pan is spaced apart an equal distance when stacked and this said space can be further utilized to store a lid thereby saving space. The cookware is held in a stable stacked position using the handles.

FIG. 5 illustrates a stackable handle embodiment as shown in in FIG. 1 and FIG. 4. Each cookware set has a single long stackable handle 22, 24, 26, extending from one side of the sidewall of the pan. The handle is attached to the sidewall of the pan using metallic insert 36. The stackable handle has an upward projection 32 in the top surface of the handle and a slot depression 34 in the bottom surface of the handle such that the upward projection in the top surface of a bottom handle 22 fits and locks in 50 with the slot depression in the bottom surface of a top handle 24. Since the projections are provided at proximal ends of handles, it would not hurt users while holding the containers using handles.

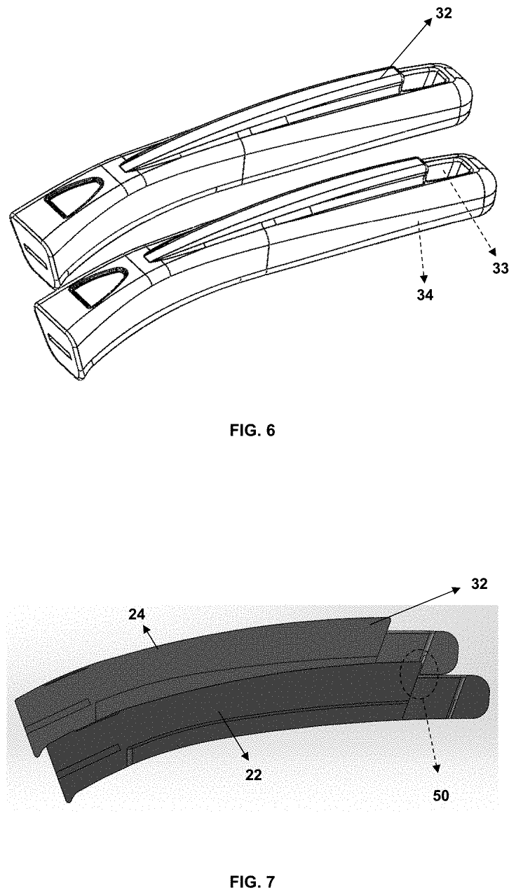

FIG. 6 illustrates a stackable handle in accordance with one or more embodiments of the present invention where the stackable handles may be of similar length irrespective of the cookware size. The handle also has an open hole or aperture 33 to enable hanging the cookware 10.

FIG. 7 illustrates a side view of the stackable handle in accordance with one or more embodiments of the present invention. The stackable handle has an upward projection 32 in the top surface of the handle and a slot depression 34 in the bottom surface of the handle such that the upward projection in the top surface of a bottom handle 22 fits and locks in 50 with the slot depression in the bottom surface of a top handle 24.

What is claimed is:

1. A stackable cookware 10 comprising:
i) a pan 12, having a closed bottom surface 37, an open top, and a sidewall 38, said sidewall extending upwardly from a bottom surface of the said pan to the pan rim 39;
ii) a long stackable handle 22 mounted to the sidewall of the said pan wherein the said handle has an upward projection 32 at the proximal end of the top surface of the handle and a slot depression 34 at the bottom surface of the handle to enable locking 50; and
iii) optionally including a lid 42 to rest upon said pan rim, said lid having a knob 48 on its top.

2. The stackable cookware 10 as claimed in claim 1, wherein upward projection 32 in the top surface of a stackable handle is close to the upward wall of the said pan 12.

3. The stackable cookware 10 as claimed in claim 1, wherein said stackable handle 22 is attached to sidewall of said pan using metallic insert 36.

4. The stackable cookware 10 as claimed in claim 1, wherein the stackable handle 22 may be of similar length and design irrespective of the cookware size.

5. The stackable cookware 10 as claimed in claim 1, wherein the stackable handle 22 include an open hole 33 to enable hanging the cookware.

6. The stackable cookware 10 as claimed in claim 1, wherein the knob 48 can be of various shapes.

7. A stackable cookware set 10 comprising a plurality of pans 12, 14, 16 of varying size with long stackable handles 22, 24, 26 mounted to the sidewall of the said plurality of pans, said set includes a plurality of optional lids 42, 44, 46, wherein a first larger pan 12 with a first single long stackable handle 22, a second smaller pan 14 with a second single long stackable handle 24, and a third smallest pan 16 with a third single long stackable handle 26 wherein the first larger pan is the outermost pan in the stack and the third smallest pan is the innermost pan in the stack, each pan having a progressively smaller diameter and height such that the smaller pan fits within the next larger pan, the said handle has an upward projection 32 at the top surface of the handle and a slot depression 34 at the bottom surface of the handle such that the said upward projection in the handle of a first pan fits and locks in 50 with the slot depression 34 in the handle of the second pan.

8. The stackable cookware 10 as claimed in claim 7, wherein upward projection 32 in the top surface of a stackable handle is close to the upward wall of the said plurality of pans.

9. The stackable cookware 10 as claimed in claim 7, wherein the upward projection 32 in the top surface of the stackable handles 22, 24, 26 prevents the external surface of the base of one smaller pan from resting flat on the internal surface of the base of a second larger pan.

10. The stackable cookware 10 as claimed in claim 7, wherein the space 56 between the bases of two consecutive pans is further utilized to store a lid 42, 44, 46.

11. The stackable cookware 10 as claimed in claim 7, wherein said plurality of stackable handles are attached to sidewalls of said plurality of pans using metallic inserts 36.

12. The stackable cookware 10 as claimed in claim 7, wherein the stackable handles 22, 24, 26 may be of similar length and design irrespective of the cookware size.

13. The stackable cookware 10 as claimed in claim 7, wherein the stackable handles 22, 24, 26 include an open hole 33 to enable hanging the cookware.

14. The stackable cookware 10 as claimed in claim 7, wherein the knob 48 can be of various shapes.
